(19) United States
(12) Patent Application Publication
(10) Pub. No.: US 2008/0249830 A1
(43) Pub. Date: Oct. 9, 2008

(54) Appointment scheduling system

(76) Inventors: Gregory Gilman, Los Angeles, CA (US); Daniel Gilman, Providence, RI (US)

Correspondence Address: TOPE-MCKAY & ASSOCIATES, 23852 PACIFIC COAST HIGHWAY #311, MALIBU, CA, 90265, US

(21) Appl. No.: 12/074,640

(22) Filed: Mar. 4, 2008

Related U.S. Application Data
(60) Provisional application No. 60/906,760, filed on Mar. 12, 2007.

(51) Int. Cl. G06Q 10/00; G06Q 30/00

(52) U.S. Cl. 705/9

(57) ABSTRACT

The present invention relates to an online appointment scheduling system. The system is configured to register a client (e.g., doctor) and at least a first and second vendor (e.g., sales representative) with the system. The system receives from the client a set of rules for vendor appointments. A client schedule of available appointments is generated that complies with the set of rules. The client schedule is accessible by the first vendor, to allow the first vendor to book an appointment. Once booked, the appointment is designated as a pending appointment. The system then requires that the first vendor confirm the pending appointment within a confirmation window and, where upon confirmation, the appointment is designated as a confirmed appointment. Alternatively, if the first vendor fails to confirm the appointment within the confirmation window, a notification is sent to a second vendor of a now available appointment.

### PRIORITY CLAIM

The present application is a non-provisional patent application, claiming the benefit of priority of U.S. Provisional Application No. 60/906,760, filed on Mar. 12, 2007, entitled, “Medical Scheduling System.”

### FIELD OF INVENTION

The present invention relates to a scheduling system and, more particularly, to a system for managing the schedule of appointments and facilitating communication between vendors and clients, such as between medical representatives and doctors.

### BACKGROUND OF INVENTION

In the field of medical and pharmaceutical scheduling, a pharmaceutical or medical sales representative typically visits a doctor and attempts to schedule a lunch or other meal appointment to pitch or otherwise market a particular pharmaceutical or medical product. Although an appointment may be set, in many cases, either the sales representative or the doctor may cancel the appointment. In some cases, a lack of communication between the two parties results in “no-shows,” where either the doctor or sales representative is present for the appointment while the other party has cancelled the appointment. Such “no-shows” can be extremely inefficient and costly for both parties involved. For example, according to some estimates, pharmaceutical companies spend more than $20 billion a year on in-office marketing to physicians. It is also estimated that at least 10 percent of the appointments are “no-shows.” Thus, approximately $1 billion a year is lost by pharmaceutical companies due to inefficient scheduling. As can be appreciated by one skilled in the art, similar issues exist in many other industries where appointments are made between vendors (sales representatives) and corresponding clients.

Thus, a continuing need exists for a scheduling system that increases communication between sales representatives and end clients, which allows the sales representatives to reschedule or fill-in for cancelled appointments, while simultaneously eliminating the hassles and inconveniences associated with missed appointments for the clients (e.g., doctors).

### SUMMARY OF INVENTION

The present invention relates to appointment scheduling system that improves efficiencies between and maintains client-vendor relationships. The scheduling system comprises an internet accessible processor. The processor is configured to register a client with the system. Once registered, the system receives from the client a set of rules for vendor appointments. At least a first vendor and a second vendor are also registered with the system. The system is also configured to generate a client schedule of available appointments that comply with the set of rules. The client schedule of available appointments is provided to the first vendor, allowing the first vendor to book an appointment within the client schedule. A booked appointment is designated as a pending appointment. The first vendor is required to confirm the pending appointment within a pre-specified window of time, where upon confirmation, the appointment is designated as a confirmed appointment. When the pending appointment is not confirmed within the pre-specified window of time, a notification of an available appointment is sent to a second vendor, allowing the second vendor to confirm the available appointment.

The system (e.g., processor) is also configured to receive and store client sample drop-off rules that include the client's preferences for sample drop-offs. In receiving sample drop-off rules, the processor is configured to prompt the client to specify whether or not the client will accept samples and, if so, when. Additionally, the system is configured to allow a vendor to access the client schedule for both sample drop-off's and available appointments.

In another aspect, the system is further configured to allow the first vendor to cancel a pending appointment, where upon cancellation, the notification of an available appointment is sent to a second vendor.

In yet another aspect, the system is further configured to allow the client to designate office closures where the client's office is unavailable for appointments, with the schedule of available appointments being generated to reflect the office closures.

Additionally, the system is further configured to prompt the client to input providers that are present at a specified location on specified dates.

In another aspect, the system is further configured to generate a vendor schedule, where pending appointments are designated as pending appointments on both the vendor schedule and client schedule.

In yet another aspect, the system is further configured to generate a vendor schedule, wherein confirmed appointments are designated as confirmed appointments on both the vendor schedule and the client schedule.

Additionally, the system is further configured to receive sample requests by the client and direct the sample request to the vendor.

Finally, the present invention also comprises a computer program product and method. The computer program product comprises computer-readable instruction means stored on a computer-readable medium that are executable by a computer for causing the computer to perform the operations describe herein. Further, the method comprises a plurality of acts embodying said operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of an appointment scheduling system of the present invention;

FIG. 2 is an illustration depicting an Internet-based system for on-line scheduling between a vendor and clients, according to the present invention;

FIG. 3 is an illustration of a computer program product according to the present invention;

FIG. 4 is an illustration of a graphical user interface, allowing a client to input into the system rules for vendor appointments;

FIG. 5 is an illustration of a graphical user interface, allowing a client to input into the system office closures;

FIG. 6 is an illustration of a graphical user interface, allowing a client to add providers into the system;

FIG. 7 is an illustration of a graphical user interface, allowing a client to input into the system sample drop-off rules;

FIG. 8 is an illustration of a graphical user interface, illustrating a schedule with available appointments that are available for booking;

FIG. 9 is an illustration of the schedule, showing a previously available appointment being booked and designated as a pending appointment;

FIG. 10 is an illustration of the schedule, showing the previously pending appointment as being confirmed and designated as a confirmed appointment;

FIG. 11 is an illustration of a vendor-side graphical user interface, showing confirmed appointments, pending appointments, and notifications of available/cancelled appointments; and

FIG. 12 is an illustration of the vendor-side graphical user interface, showing a notification of a newly available appointment.

### DETAILED DESCRIPTION

The present invention relates to a scheduling system and, more particularly, to a system for managing the schedule of appointments and facilitating communication between vendors and clients, such as between pharmaceutical or medical sales representatives and doctors. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a description of various principal aspects of the present invention is provided. Subsequently, an introduction provides the reader with a general understanding of the present invention. Finally, details of the present invention are provided to give an understanding of the specific aspects.

(1) Principal Aspects

The present invention has three “principal” aspects. The first is a scheduling system. The scheduling system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

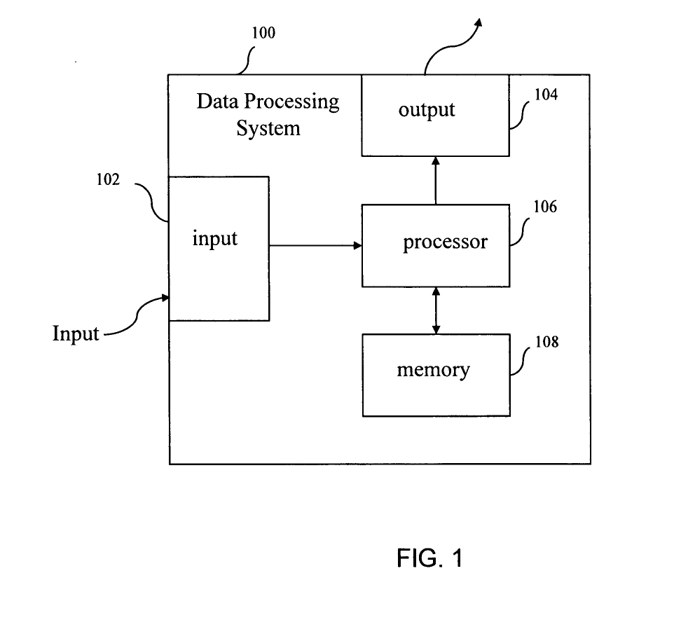

A block diagram depicting the components of a scheduling system of the present invention is provided in FIG. 1. The scheduling system 100 comprises an input 102 for receiving scheduling information from at least one user. Note that the input 102 may include multiple “ports.” An output 104 is connected with the processor for providing scheduling information to a user or to other systems in order that a network of computer systems may serve as a scheduling system. Output may also be provided to other devices or other programs; e.g., to other software modules, for use therein. The input 102 and the output 104 are both coupled with a processor 106, which may be a general-purpose computer processor or a specialized processor designed specifically for use with the present invention. The processor 106 is coupled with a memory 108 to permit storage of data and software that are to be manipulated by commands to the processor 106.

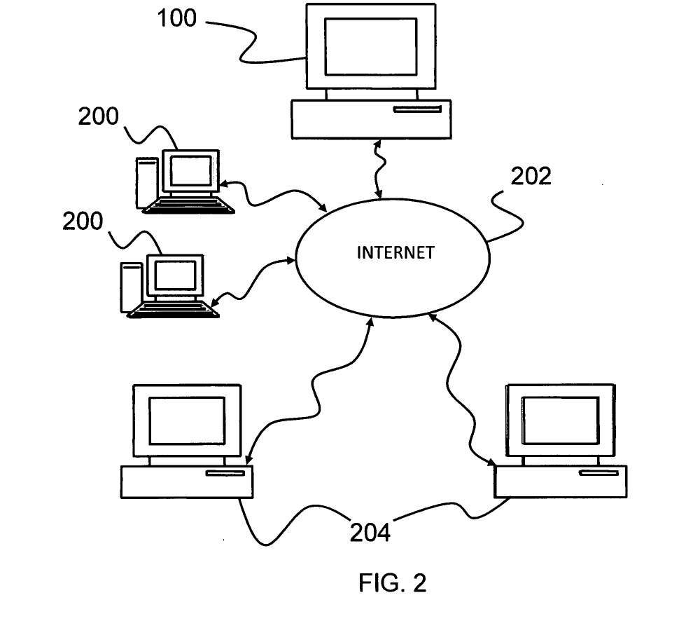

As can be appreciated by one skilled in the art, the scheduling system can be operated on-line, to allow for on-line scheduling. FIG. 2 illustrates a data processing system 100 (e.g., server computer/processor) incorporating the on-line operations described herein. The present invention utilizes the data processing system 100 for storing the client and vendor preferences, and also for scheduling the appointments and performing the operations described herein. The data processing system 100 and its corresponding interface may be accessible by a user's (e.g., vendor or client) computer over the Internet 202. For example, vendor's can access the system 100 on-site or remotely through the Internet 202 using vendor computers 200. Additionally, when an Internet-accessible user interface is included in the system, the user interface (e.g., web page) may be stored on the data processing system 100 and may be accessible over the Internet 202 by a plurality of clients 204, allowing the plurality of clients 204 to interface with the system. Additionally, as can be appreciated by one skilled in the art, the system 100 can be configured such that a plurality of vendors 200 can also interface with the system 100 to access and schedule according to a client's preference 204.

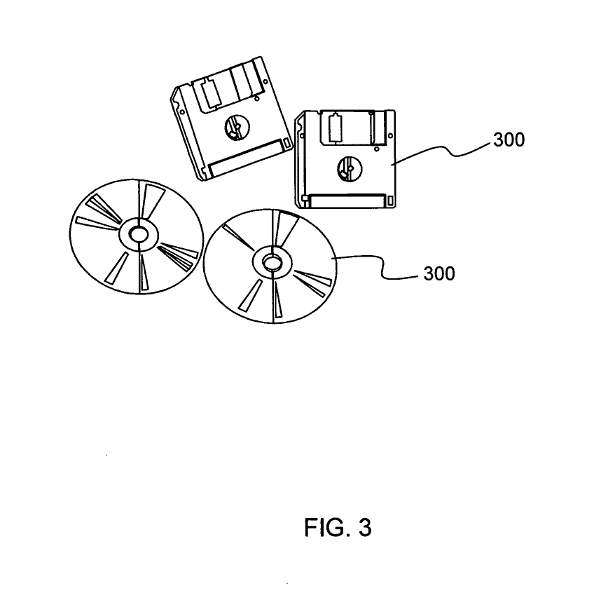

An illustrative diagram of a computer program product embodying the present invention is depicted in FIG. 3. The computer program product 300 is depicted as an optical disk such as a CD or DVD. However, as mentioned previously, the computer program product generally represents computer-readable instruction means stored on any compatible computer-readable medium. The term “instruction means” as used with respect to this invention generally indicates a set of operations to be performed on a computer, and may represent pieces of a whole program or individual, separable, software modules. Non-limiting examples of “instruction means” include computer program code (source or object code) and “hard-coded” electronics (i.e. computer operations coded into a computer chip). The “instruction means” may be stored in the memory of a computer or on a computer-readable medium such as a floppy disk, a CD-ROM, and a flash drive.

(2) Introduction

The present invention is a simple, intuitive scheduling system to maintain and manage vendor relationships. The system provides an on-line interface to facilitate the scheduling of appointments and communications between clients (e.g., doctors) and vendors (e.g., pharmaceutical sales representatives).

To be contrasted with existing scheduling systems, the present invention provides an interface that is accessible by both the client and the sales representative. The interface lists scheduled appointments as “pending” until confirmed by the sales representative shortly before the actual appointment. If the sales representative does not confirm the appointment, the appointment is cancelled and a notification is sent out to other sales representatives in the territory.

This provides a degree of transparency to the relationship that does not currently exist. The transparency in scheduling allows users to recognize enormous gains in efficiency. For example, based on the notification that is sent out, other sales representatives can fill in for the cancelled appointments. Thus, instead of a “no-show,” another sales representative can fulfill the appointment and thereby increase marketing efficiencies.

Additionally, “no-shows” generate a tremendous amount of ill-will. Therefore, by enabling other sales representatives to fulfill the appointment, the client-vendor relationship is maintained and intact.

In summary, the present invention is an on-line scheduling system that maximizes scheduling efficiencies between vendors and clients while maintaining the client-vendor relationship. It should be noted that while the present invention is analogized as being applicable to the pharmaceutical or medical sales representative and doctor relationship, it can be applied to any suitable industry where appointment scheduling exists.

(3) Details of the Invention

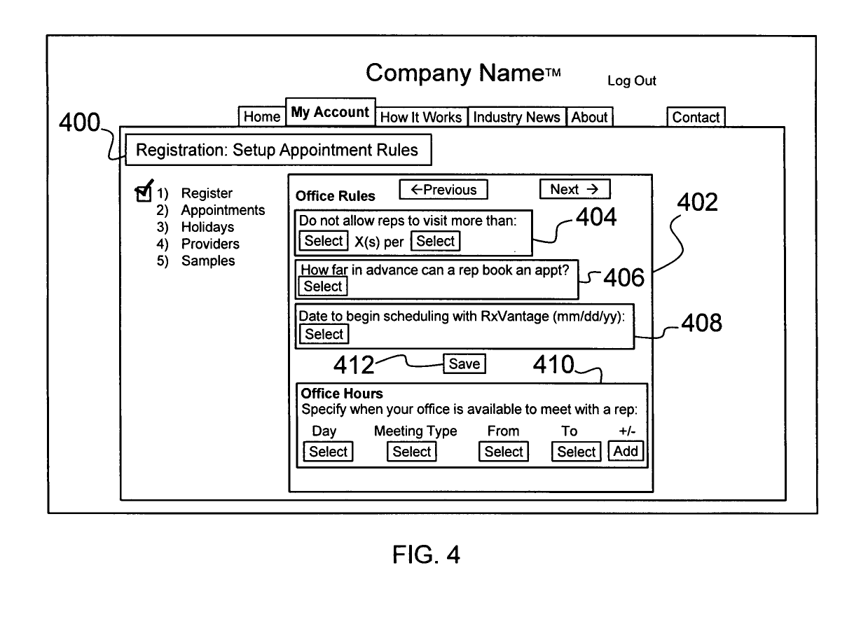

As described above, the present invention is an on-line scheduling system that facilitates client-vendor appointments. FIGS. 4 through 12 illustrate examples of screen shots that depict the various operations according to the present invention. Although the operations will be listed sequentially, one skilled in the art can appreciate that the present invention is not intended to be limited thereto as the operations or acts can be performed in any order, provided that the end result is a confirmed or cancelled appointment.

As shown in FIG. 4, the system is configured to allow clients to register 400 with the system. In registering 400, the clients are prompted for a variety of data, such as names, contact information, preferences, etc. Additionally, the clients are prompted to input a set of rules 402 for vendor visitations (i.e., appointments). The rules can be manually entered or selected using a series of drop down menus. Non-limiting examples of such rules include: the maximum number of office visits per a selected amount of time 404 (e.g., one office visit per week); the amount of time in advance that the client requires the vendor to book an appointment 406 (e.g., one week); a start date to begin scheduling with the system 408 (e.g., immediately or mm/dd/yyyy) and; the days, type, and times in which the client is available to meet with the vendor's representatives 440. Finally, the system is configured to allow the user (e.g., client) save 442 the data for later use by both the client and vendor.

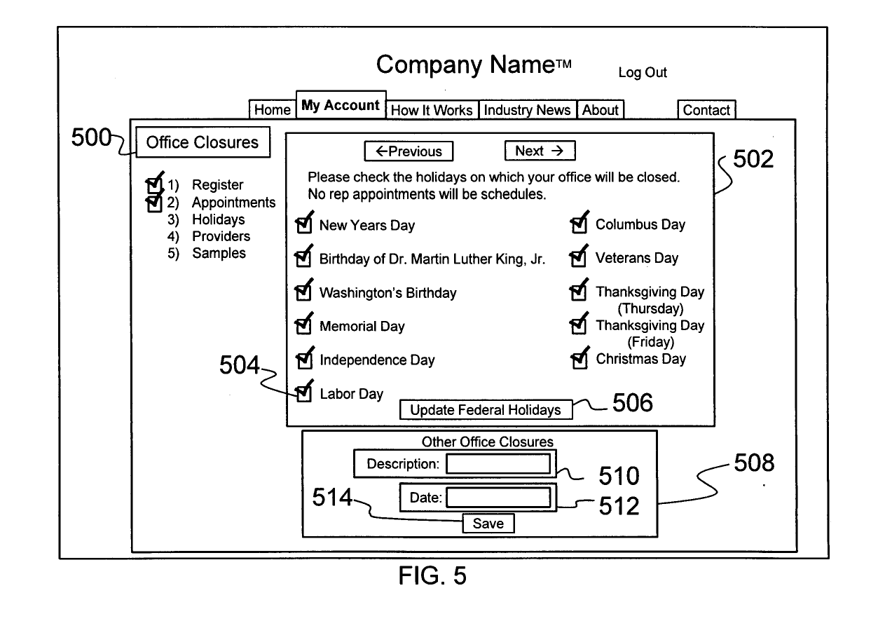

Next, as shown in FIG. 5, the system prompts the user to input office closures 500. In other words, the system requests that the user designate particular dates in which the user or office is unavailable for appointments. For example, the system is configured to allow the user to select holidays 502 in which the user's office is closed or otherwise unavailable for appointments. For example, the system provides an interface with a list of Federal Holidays (e.g., New Year's Day, Labor Day, Veterans Day, etc) and a box checking function 504 that allows the user to select or de-select particular holidays. The user's preferences can then be saved by updating 506 the Federal Holiday preferences. As another feature, the user can input Other Office Closures 508. This feature allows the client to provide a description 510 and date 512 (and/or time) that the client's office is closed. As was the case with the holidays 502, the user can save 514 the preferences by updating and adding them to the system (and its corresponding client database).

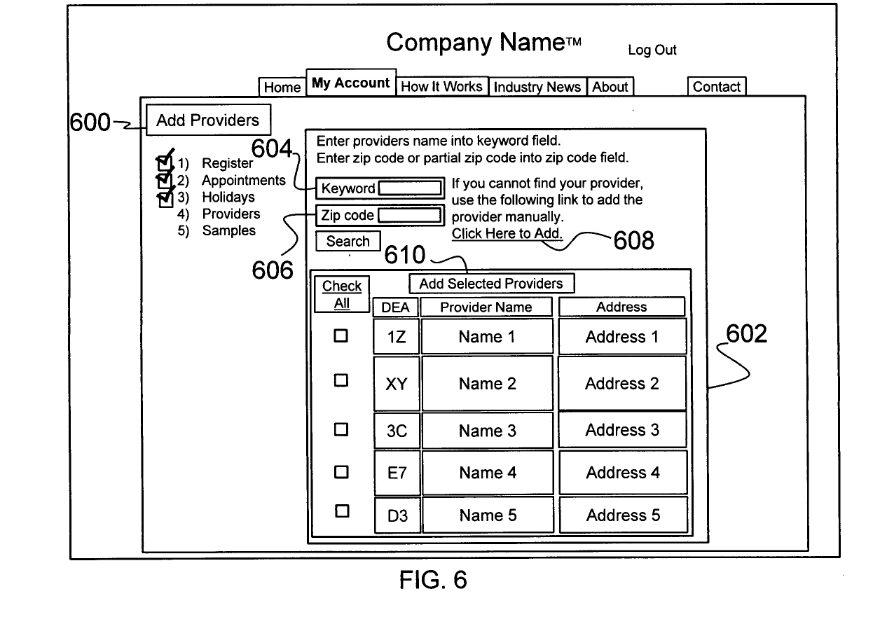

As shown in FIG. 6, the system is configured to prompt the user/client to add providers 600. In other words, the user is prompted to select the providers 602 (e.g., doctors) that are present at certain specified locations (e.g., addresses) on specified dates. Thus, a medical office manager using the system can designate which doctors satisfy the specifications as described above. To assist the user in finding the provider, the system includes search tools. For example, the system includes keyword 604 and zip code 606 search tools. If the provider is not in the database, the user can select a link 608, which retrieves an additional screen that allows the user to add the provider manually. Once the providers are selected, the user can add 610 the selected providers into the system's preferences for that particular client.

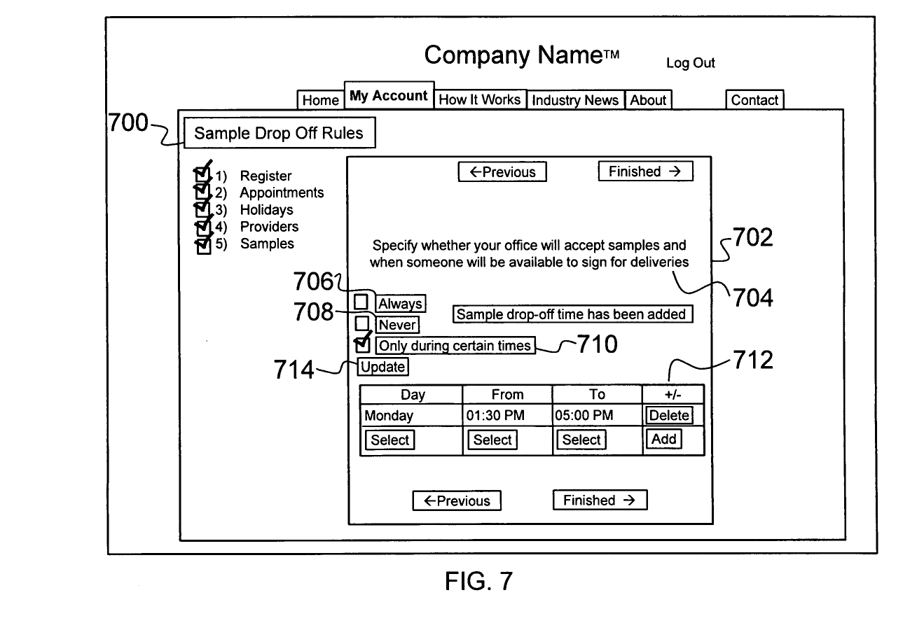

As another option and as depicted in FIG. 7, the client is prompted to input sample drop-off rules 700. In other words, the system is configured to obtain and track each client's sample preferences 702. For example, the client is prompted to specify whether or not the office will accept samples 704 and, if so, when someone will be available to sign for deliveries. As a non-limiting example, such preference options include always 706, never 708, and only during certain times 710. If the client requires that samples only be delivered during certain times 710, then the client is prompted to input the certain times 712 (such as dates (e.g., Monday, etc.) and to-and-from time periods). As is the case with other preferences, the sample drop-off rules can be updated 714 and saved into the system for use by the vendor, client, etc. Further, the system can be configured such that the clients can request samples directly from the vendors, who can be required to input the particular items (e.g., medications) that they carry in order to use the system. The system them directs the sample requests to the vendor.

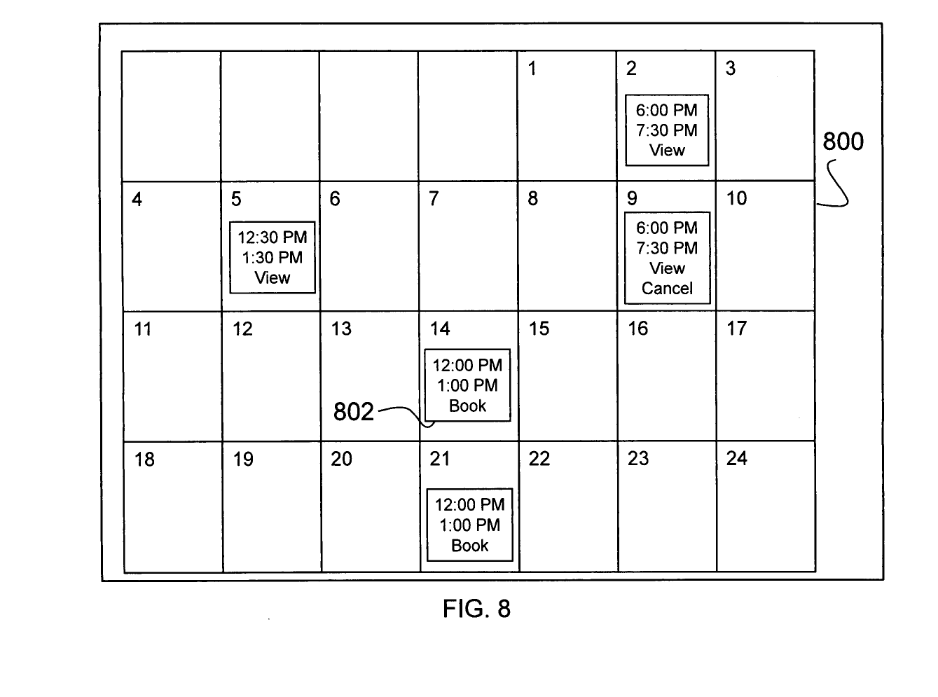

As shown in FIG. 8, when the client's preferences are set, a vendor (e.g., sales representative) can access a particular client or office schedule 800 to view availability for both sample drop-off's and appointments. The vendor can review the client's schedule 800 and then book 802 appointments in the applicable time slot. For example and as shown in FIG. 8, the vendor can select to book 802 an appointment on the 14^{th} day of the month between 12:00 p.m. and 1:00 p.m.

The vendor can access the clients' schedules in a variety of ways. For example, the vendor can search through a database of clients by area code, pre-designated territory, etc. As a more specific example, a particular vendor can perform a search by searching through a particular area code and a window of dates to identify clients with available appointments that comply with the search parameters. In another aspect, particular clients are assigned to particular vendors. As such, when the vendor retrieves a calendar, the assigned vendors with available appointments are generated on the vendor's calendar, allowing the vendor to book, confirm, etc. the appointments.

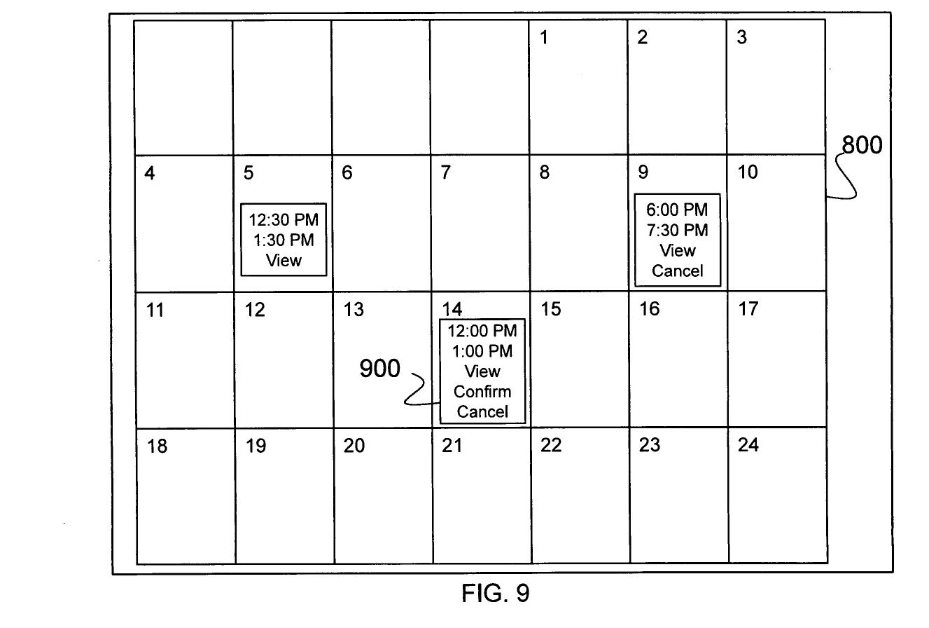

As shown in FIG. 9, once the vendor books a particular time slot, the client's schedule 800 lists the appointment as pending 900. The appointment will be designated as “pending” on both the client (e.g., doctor) and vendor (e.g., pharmaceutical sales representative) schedules. The designation is made using any suitable technique for designating something, non-limiting examples of which include textual labels and color coding. For example, the time slot can be changed from “white,” which allows the vendor to book an appointment, to “yellow,” which indicates that the appointment is “pending.”

The appointment is designated as “pending” 900 until a confirmation window is available. The confirmation window opens a predetermined number of days before the actual appointment date and serves as a pre-specified window of time within which the appointment must be confirmed. As a non-limiting example, the confirmation window opens ten days prior to the appointment. Thereafter, the vendor must then confirm the appointment before a predetermined amount time prior to the actual appointment time (at which point the confirmation window closes). As a non-limiting example, the system can be configured such that the vendor must confirm the appointment at least 72 hours in advance.

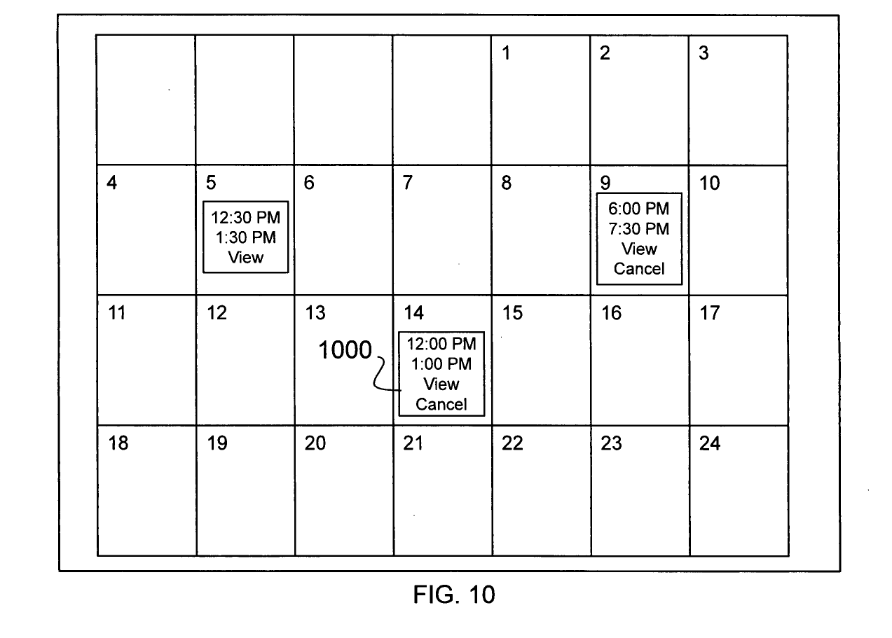

As shown in FIG. 10, once the vendor confirms the appointment, a “confirmed” indicator 1000 is provided to both the vendor and client. For example, the confirmed indicator 1000 is provided in both the vendor's schedule and the client's schedule. The confirmed indicator 1000 is made using any suitable technique for designating something, non-limiting examples of which include textual labels and color coding. For example, the time slot can be changed from “yellow” (which indicated that the appointment was pending) to “green,” which now indicates that the appointment has been confirmed.

If the vendor does not confirm the appointment prior to the close of the confirmation window, the system cancels the appointment and sends a cancelled/available appointment notification to other suitable vendors. As a non-limiting example, a notification is sent out to other sales representatives that service the area of the appointment. Upon receipt of the notification, another sales representative can then fill in for the cancelled appointment and confirm the appointment. An advantage to this system is that it allows for vendors to fill in for cancelled appointments that otherwise would have been no-shows.

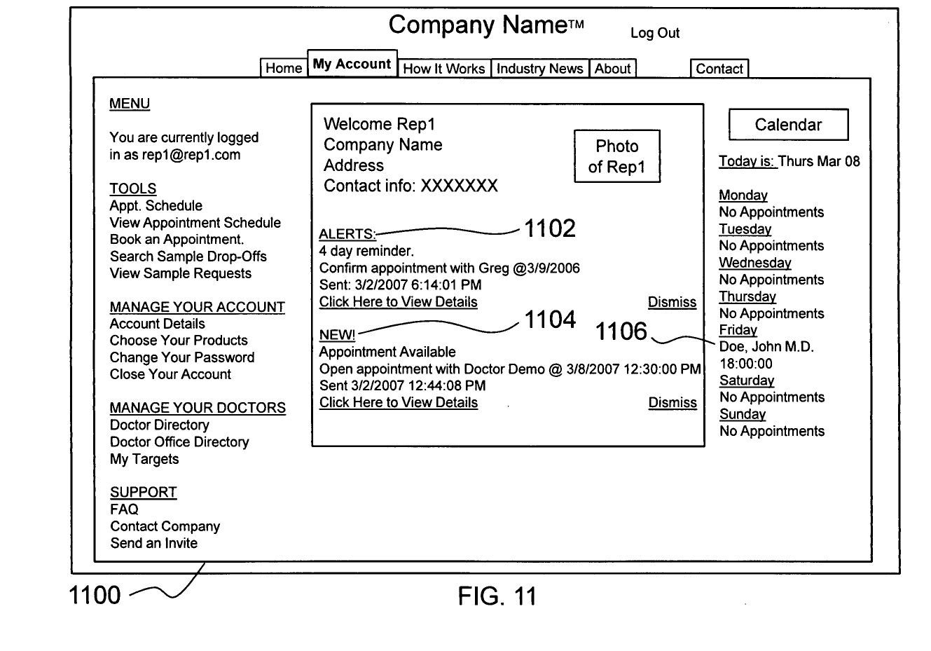

The notification of cancelled/available appointments is sent to other suitable vendors using any suitable notification technique, non-limiting examples of which include e-mail and on-site alerts. FIG. 11 is a screenshot of vendor-side interface 1100 (e.g., graphical user interface (GUI)) illustrating an on-site alert. When logging into the system, the vendor is provided with the interface 1100, which includes several pertinent alerts. For example, the vendor is provided with a confirmation reminder 1102 that is used to remind the vendor that there is a “pending” appointment that needs confirmation. Additionally, as noted above, the vendor can be provided with a cancelled/available appointment notification 1104. In this example, the cancelled/available appointment notification 1104 informs the vendor of the client, the date, and time of the available appointment. The notification 1104 also allows the vendor to view further details and confirm the appointment. Additionally, the user interface 1100 provides the vendor with confirmed appointments 1106 as a reminder of upcoming appointments.

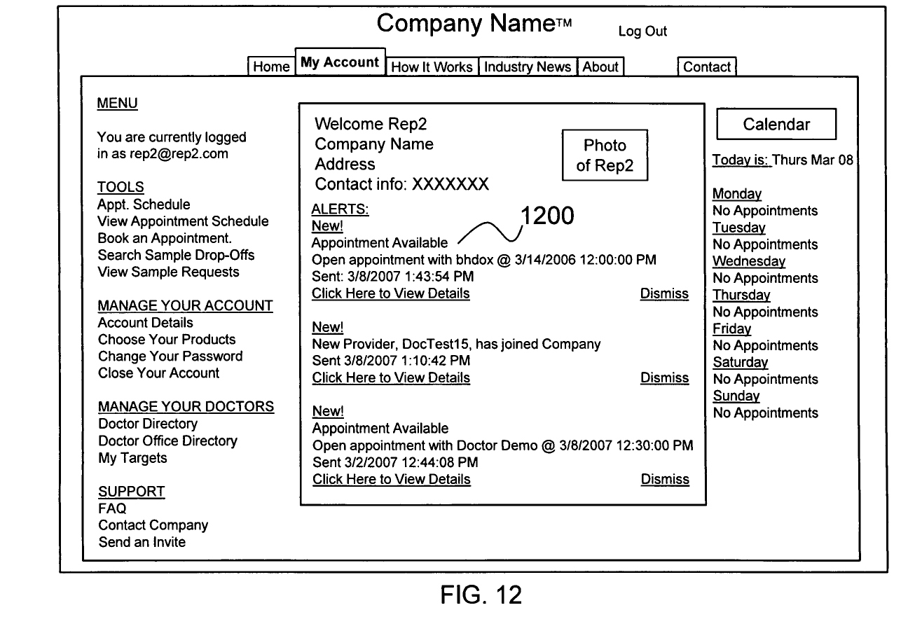

As mentioned above, if the vendor fails to confirm an appointment prior to the end of the confirmation window, a notification is sent to other vendors. However, once the appointment is confirmed, the notification is not automatically generated and the appointment is designated as confirmed. Once confirmed, the vendor then can selectively cancel the appointment. In the event that the appointment is cancelled, a similar notification is sent to other vendors regarding the cancelled appointment. As shown in FIG. 12, a previously confirmed appointment (illustrated as confirmed in FIG. 10) has been cancelled by the vendor who previously confirmed the appointment. Upon cancellation, other vendors receive the notification 1200 of cancelled/available appointments, which allows another vendor to now fill in for the cancelled appointment.

Thus, by allowing another vendor to confirm and fill in for a cancelled or non-confirmed appointment, efficiencies are improved and the client-vendor relationship is maintained and intact.

What is claimed is:

1. An appointment scheduling system, comprising:
an internet accessible processor configured to perform operations of:
registering a client with the system;
receiving from the client a set of rules for vendor appointments;
registering at least a first vendor and a second vendor with the system;
generating a client schedule of available appointments that comply with the set of rules;
providing the client schedule of available appointments to the first vendor;
allowing the first vendor to book an appointment within the client schedule, with the appointment being designated as a pending appointment;
requiring that the first vendor confirm the pending appointment within a pre-specified window of time, where upon confirmation, the appointment is designated as a confirmed appointment, and when the pending appointment is not confirmed within the pre-specified window of time, then sending a notification of an available appointment to a second vendor; and
allowing the second vendor to confirm the available appointment.

2. A system as set forth in claim 1, wherein the system is further configured to receive and store client sample drop-off rules that include the client's preferences for sample drop-offs.

3. A system as set forth in claim 2, wherein in receiving sample drop-off rules, the system is configured to prompt the client to specify whether or not the client will accept samples and, if so, when.

4. A system as set forth in claim 2, wherein the system is configured to allow a vendor to access the client schedule for both sample drop-off's and available appointments.

5. A system as set forth in claim 1, wherein the system is further configured to allow the first vendor to cancel a pending appointment, where upon cancellation, the notification of an available appointment is sent to a second vendor.

6. A system as set forth in claim 1, wherein the system is further configured to allow the client to designate office closures where the client's office is unavailable for appointments, with the schedule of available appointments being generated to reflect the office closures.

7. A system as set forth in claim 1, wherein the system is further configured to prompt the client to input providers that are present at a specified location on specified dates.

8. A system as set forth in claim 1, wherein the system is further configured to generate a vendor schedule, where pending appointments are designated as pending appointments on both the vendor schedule and client schedule.

9. A system as set forth in claim 1, wherein the system is further configured to generate a vendor schedule, wherein confirmed appointments are designated as confirmed appointments on both the vendor schedule and the client schedule.

10. A system as set forth in claim 1, wherein the system is further configured to receive sample requests by the client and direct the sample request to the vendor.

11. A system as set forth in claim 1, wherein the system is further configured to:
allow the first vendor to cancel a pending appointment, where upon cancellation, the notification of an available appointment is sent to a second vendor;
allow the client to designate office closures where the client's office is unavailable for appointments, with the schedule of available appointments being generated to reflect the office closures;
prompt the client to input providers that are present at a specified location on specified dates;
generate a vendor schedule, where pending appointments are designated as pending appointments on both the vendor schedule and client schedule, and wherein confirmed appointments are designated as confirmed appointments on both the vendor schedule and the client schedule;
receive sample requests by the client and direct the sample request to the vendor;
receive and store client sample drop-off rules that include the client's preferences for sample drop-offs, wherein in receiving sample drop-off rules, the processor is configured to prompt the client to specify whether or not the client will accept samples and, if so, when; and
allow a vendor to access the client schedule for both sample drop-off's and available appointments.

12. A computer program product for an appointment scheduling system, the computer program product comprising computer-readable instruction means stored on a computer-readable medium that are executable by a computer for causing the computer to perform operations of:
registering a client with the system;
receiving from the client a set of rules for vendor appointments;
registering at least a first vendor and a second vendor with the system;
generating a client schedule of available appointments that comply with the set of rules;
providing the client schedule of available appointments to the first vendor;
allowing the first vendor to book an appointment within the client schedule, with the appointment being designated as a pending appointment;
requiring that the first vendor confirm the pending appointment within a pre-specified window of time, where upon confirmation, the appointment is designated as a confirmed appointment, and when the pending appointment is not confirmed within the pre-specified window of time, then sending a notification of an available appointment to a second vendor; and
allowing the second vendor to confirm the available appointment.

13. A computer program product as set forth in claim 12, further comprising instructions means for causing a computer to receive and store client sample drop-off rules that include the client's preferences for sample drop-offs.

14. A computer program product as set forth in claim 13, further comprising instructions means for causing a computer to prompt the client to specify whether or not the client will accept samples and, if so, when.

15. A computer program product as set forth in claim 13, further comprising instructions means for causing a computer to allow a vendor to access the client schedule for both sample drop-off's and available appointments.

16. A computer program product as set forth in claim 12, further comprising instructions means for causing a computer to allow the first vendor to cancel a pending appointment, where upon cancellation, the notification of an available appointment is sent to a second vendor.

17. A computer program product as set forth in claim 12, further comprising instructions means for causing a computer to allow the client to designate office closures where the client's office is unavailable for appointments, with the schedule of available appointments being generated to reflect the office closures.

18. A computer program product as set forth in claim 12, further comprising instructions means for causing a computer to prompt the client to input providers that are present at a specified location on specified dates.

19. A computer program product as set forth in claim 12, further comprising instructions means for causing a computer to generate a vendor schedule, where pending appointments are designated as pending appointments on both the vendor schedule and client schedule.

20. A computer program product as set forth in claim 12, further comprising instructions means for causing a computer to generate a vendor schedule, wherein confirmed appointments are designated as confirmed appointments on both the vendor schedule and the client schedule.

21. A computer program product as set forth in claim 12, further comprising instructions means for causing a computer to receive sample requests by the client and direct the sample request to the vendor.

22. A computer program product as set forth in claim 12, further comprising instructions means for causing a computer to perform operations of:
allowing the first vendor to cancel a pending appointment, where upon cancellation, the notification of an available appointment is sent to a second vendor;
allowing the client to designate office closures where the client's office is unavailable for appointments, with the schedule of available appointments being generated to reflect the office closures;
prompting the client to input providers that are present at a specified location on specified dates;
generating a vendor schedule, where pending appointments are designated as pending appointments on both the vendor schedule and client schedule, and wherein confirmed appointments are designated as confirmed appointments on both the vendor schedule and the client schedule;
receiving sample requests by the client and direct the sample request to the vendor;
receiving and storing client sample drop-off rules that include the client's preferences for sample drop-offs, wherein in receiving sample drop-off rules, the processor is configured to prompt the client to specify whether or not the client will accept samples and, if so, when; and
allowing a vendor to access the client schedule for both sample drop-off's and available appointments.

23. A method for appointment scheduling, comprising acts of:
registering a client with an appointment scheduling system operating on an internet accessible processor;
receiving from the client a set of rules for vendor appointments;
registering at least a first vendor and a second vendor with the system;
generating a client schedule of available appointments that comply with the set of rules;
providing the client schedule of available appointments to the first vendor;
allowing the first vendor to book an appointment within the client schedule, with the appointment being designated as a pending appointment;
requiring that the first vendor confirm the pending appointment within a pre-specified window of time, where upon confirmation, the appointment is designated as a confirmed appointment, and when the pending appointment is not confirmed within the pre-specified window of time, then sending a notification of an available appointment to a second vendor; and
allowing the second vendor to confirm the available appointment.

24. A method as set forth in claim 23, further comprising acts of receiving and storing client sample drop-off rules that include the client's preferences for sample drop-offs.

25. A method as set forth in claim 24, further comprising an act of prompting the client to specify whether or not the client will accept samples and, if so, when.

26. A method as set forth in claim 24, further comprising an act of allowing a vendor to access the client schedule for both sample drop-off's and available appointments.

27. A method as set forth in claim 23, further comprising an act of allowing the first vendor to cancel a pending appointment, where upon cancellation, the notification of an available appointment is sent to a second vendor.

28. A method as set forth in claim 23, further comprising an act of allowing the client to designate office closures where the client's office is unavailable for appointments, with the schedule of available appointments being generated to reflect the office closures.

29. A method as set forth in claim 23, further comprising an act of prompting the client to input providers that are present at a specified location on specified dates.

30. A method as set forth in claim 23, further comprising an act of generating a vendor schedule, where pending appointments are designated as pending appointments on both the vendor schedule and client schedule.

31. A method as set forth in claim 23, further comprising an act of generating a vendor schedule, wherein confirmed appointments are designated as confirmed appointments on both the vendor schedule and the client schedule.

32. A method as set forth in claim 23, further comprising acts of receiving sample requests by the client and directing the sample request to the vendor.

33. A method as set forth in claim 23, further comprising acts of:
allowing the first vendor to cancel a pending appointment, where upon cancellation, the notification of an available appointment is sent to a second vendor;
allowing the client to designate office closures where the client's office is unavailable for appointments, with the schedule of available appointments being generated to reflect the office closures;
prompting the client to input providers that are present at a specified location on specified dates;
generating a vendor schedule, where pending appointments are designated as pending appointments on both the vendor schedule and client schedule, and wherein confirmed appointments are designated as confirmed appointments on both the vendor schedule and the client schedule;
receiving sample requests by the client and direct the sample request to the vendor;
receiving and storing client sample drop-off rules that include the client's preferences for sample drop-offs, wherein in receiving sample drop-off rules, the processor is configured to prompt the client to specify whether or not the client will accept samples and, if so, when; and
allowing a vendor to access the client schedule for both sample drop-off's and available appointments.
